(19) United States
(12) Patent Application Publication
(10) Pub. No.: US 2026/0348492 A1
(43) Pub. Date: Nov. 5, 2026

(54) MULTI-CONFIGURATION CABLE CLIP

(71) Applicant: Molex, LLC, Lisle, IL (US)

(72) Inventors: Hui-Chin Yang, New Taipei City (TW); Tung-Min Chen, New Taipei City (TW); Christopher Richard Pinkham Basa, St. Paul, MN (US); Trevor Dean Smith, Eden Prairie, MN (US); Wenzong Chen, Naperville, IL (US)

(21) Appl. No.: 19/379,184

(22) Filed: Nov. 4, 2025

Related U.S. Application Data
(60) Provisional application No. 63/726,211, filed on Nov. 27, 2024.

(51) Int. Cl. F16L 3/13; F16L 3/223

(52) U.S. Cl. CPC F16L 3/13; F16L 3/223

(57) ABSTRACT

An example cable clip includes a first section comprising a first lower surface, a second section comprising a second lower surface, and a connector portion coupling the first section to the second section. The first section and the second section are movably coupled to one another about the connector portion such that the first section and the second section are positionable between a side-by-side configuration and a top-and-bottom configuration in which the first lower surface and the second lower surface face one another. The cable clip also includes a plurality of channels positioned in each of the first section and the second section, wherein the plurality of channels are configured to receive and retain a plurality of cables therein.

### CROSS-REFERENCE TO RELATED APPLICATION

This application claims the benefit of and priority to U.S. Provisional Patent Application No. 63/726,212 filed Nov. 27, 2024, the contents of which being incorporated by reference in its entirety herein.

### TECHNICAL FIELD

The present disclosure relates to cable management devices, and more particularly to a cable clip cable of multiple configurations for organizing and routing multiple cables.

### BACKGROUND

Cable management is an important aspect of many electronic and electrical systems, particularly in environments where multiple cables need to be organized, routed, and secured (e.g., data centers, telecommunication stations, and like facilities). Effective cable management can improve system reliability, ease maintenance, enhance aesthetics, and ensure safety by preventing tangling, strain, and accidental disconnections. However, traditional cable management solutions often lack flexibility, making it challenging to accommodate varying numbers of cables or adapt to different spatial constraints.

### BRIEF SUMMARY

According to an aspect of the present disclosure, a cable clip is provided. The cable clip includes a first section comprising a first lower surface, a second section comprising a second lower surface, and a connector portion coupling the first section to the second section. The first section and the second section are movably coupled to one another about the connector portion such that the first section and the second section are positionable between a side-by-side configuration and a top-and-bottom configuration in which the first lower surface and the second lower surface face one another, among other potential configurations. The cable clip also includes a plurality of channels positioned in each of the first section and the second section, where the plurality of channels are configured to receive and retain a plurality of cables therein.

The cable clip may further include a slit positioned above the connector portion and between the first section and the second section that separates the first section from the second section. The cable clip may further include a latch positioned on a distal end of the first section, and a tab positioned on a distal end of the second section, where the latch is configured to engage with and retain the tab when the first section and the second section are in the top-and-bottom configuration.

Each of the plurality of channels can be annular-shaped, and each of the plurality of channels can be configured to form an interference fit with a respective one of the plurality of cables. The connector portion can include a notched lower surface positioned between the first lower surface and the second lower surface. The notched lower surface can have a semi-circular or triangular cross-section that facilitates deformation of the notched lower surface. The first section, the second section, and the connector portion can be integral with one another, and can be formed of a single injection molded polymer material.

The cable clip may further include a plurality of ridges positioned between each of the plurality of channels. The ridges can be formed or otherwise configured to deflect upon insertion of a respective one of the plurality of cables. A number of the plurality of channels in the first section can be the same as a number of the plurality of the channels in the second section.

According to another aspect of the present disclosure, a cable clip is provided. The cable clip includes an integral body comprising a first section and a second section, and a connector portion coupling the first section to the second section. The first section and the second section are movably coupled to one another about the connector portion. The integral body further includes a plurality of channels positioned in each of the first section and the second section, where the plurality of channels are configured to receive and retain a plurality of cables therein.

The connector portion can be configured such that the first section and the second section are adjustable between a side-by-side configuration and a top-and-bottom configuration in which a first lower surface of the first section and a second lower surface of the second section are positioned adjacent one another. The integral body can further include a slit positioned above the connector portion and between the first section and the second section that separates the first section from the second section. The integral body can further include a latch positioned on a distal end of the first section, and a tab positioned on a distal end of the second section, where the latch is configured to engage with and retain the tab when the first section and the second section are in the top-and-bottom configuration.

Each of the plurality of channels can be annular-shaped. Moreover, each of the plurality of channels can be configured to form an interference fit with a respective one of the plurality of cables. The connector portion can include a notched lower surface positioned between the first lower surface and the second lower surface. The notched lower surface can have a semi-circular or triangular cross-section that facilitates deformation of the notched lower surface. The first section, the second section, and the connector portion can be integral with one another, and can be formed of a single injection molded polymer material. The cable clip can further include a plurality of ridges positioned between each of the plurality of channels, the ridges being configured to deflect upon insertion of a respective one of the plurality of cables. A number of the plurality of channels in the first section can be the same as a number of the plurality of the channels in the second section.

The foregoing general description of the illustrative embodiments and the following detailed description thereof are merely exemplary aspects of the teachings of this disclosure and are not restrictive.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a top perspective view of a cable clip in a first configuration according to various embodiments of the present disclosure.

FIG. 2 is a bottom perspective view of the cable clip in the first configuration according to various embodiments of the present disclosure.

FIG. 3 is another bottom perspective view of the cable clip in the first configuration according to various embodiments of the present disclosure.

FIG. 4 is another top perspective view of the cable clip in the first configuration according to various embodiments of the present disclosure.

FIG. 5 is a bottom perspective view of the cable clip in a second configuration according to various embodiments of the present disclosure.

FIG. 6 is a top perspective view of the cable clip in the second configuration according to various embodiments of the present disclosure.

FIG. 7 is a top perspective view of a connector assembly featuring the cable clip in the first configuration according to various embodiments of the present disclosure.

FIG. 8 is a top perspective view of a connector assembly featuring the cable clip in the second configuration according to various embodiments of the present disclosure.

FIG. 9 is a bottom perspective view of a connector assembly featuring the cable clip in the second configuration according to various embodiments of the present disclosure.

### DETAILED DESCRIPTION

The present disclosure relates to a multi-configuration cable clip or, more specifically, to a cable clip that can be transitioned among different configurations depending on a desired orientation of the cable clip and/or cables attached thereto.

Routing cables in tight spaces or complex environments can present significant challenges for system designers and installers. In confined areas, such as server racks, automotive interiors, or compact electronic devices, the limited space may make it difficult to properly organize and separate cables. This can lead to cable bunching, tangling, or excessive bending, which can cause damage to cables and compromise signal integrity. Additionally, in implementations where cables are routed through narrow passages or around obstacles, maintaining proper cable spacing and avoiding interference among a multitude of varying signal types can be challenging.

Cable clips can serve to organize cables but can also provide stability and act as stiffeners to prevent degradation of the cables. By securing cables at regular intervals, cable clips can help maintain proper cable spacing, reduce strain on connectors, and minimize the risk of accidental disconnections. By positioning cable clips near ends of cables, a stiffening effect can be provided that can help prevent excessive cable movement and vibration. Furthermore, by keeping cables properly organized and supported, cable clips can help maintain optimal bend orientations, reducing the risk of signal attenuation or physical damage that can occur when cables are bent too sharply or allowed to sag under their own weight.

Accordingly, various embodiments for a transitionable cable clip are disclosed. The cable clip can include a first section and a second section coupled by a connector portion. In some embodiments, the first section and the second section can be movably coupled to one another about the connector portion. For instance, the first section and the second section can fold and/or pivot relative to one another. Thus, the cable clip can be configured to transition between a side-by-side configuration (e.g., an unfolded configuration) and a top-and-bottom (e.g., a folded) configuration, among other potential configurations. In various embodiments, the cable clip can include one or more channels positioned in at least one of the first section and the second section. These channels can be configured to receive and retain one or more cables, as can be appreciated.

In various embodiments, the cable clip can be formed as a single injection molded piece, which in some cases may be made of a plastic or polymer material. In some embodiments, the channels in the cable clip or, more specifically, ridges positioned between the channels, can undergo some level of deflection during the insertion of cables, before relaxing into a position that overlaps most of the cable surface area. The cables may be constrained axially within the channels, while allowing for some movement in other directions to facilitate complete insertion.

The cable clip described herein may provide advantages in various cable management scenarios. For example, the transitionable nature of the cable clip allows for adaptability in different spatial constraints. The ability to securely hold multiple cables while allowing for easy insertion and removal may enhance usability in various electronic and electrical systems. Even further, a cable boot is designed to prevent a cable at an end of a connector from bending sharply, which can cause signal loss. In some implementations, to ensure the connector and cable function correctly and meet industrial standards (e.g., GR-1435-Core), the cable clip as described herein can be removed once any connectors retained therein are mated.

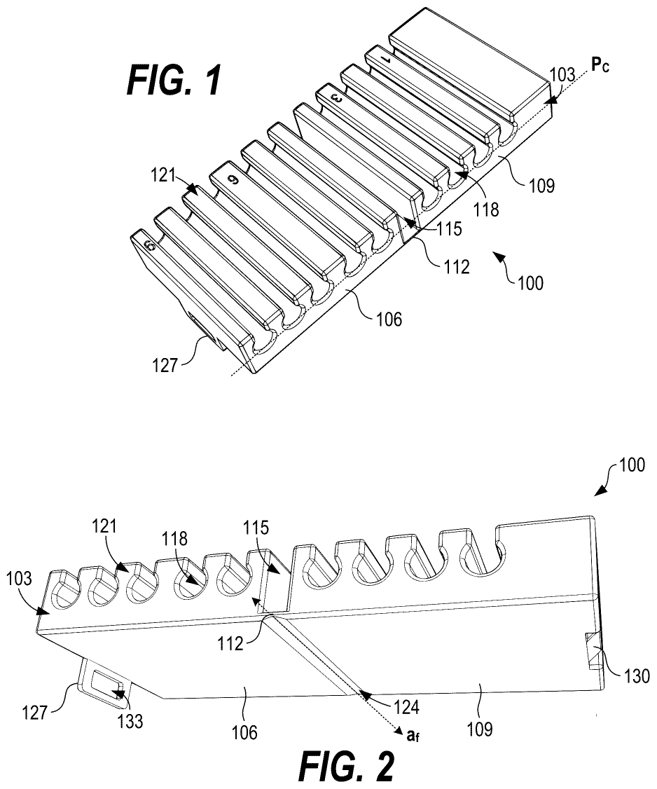

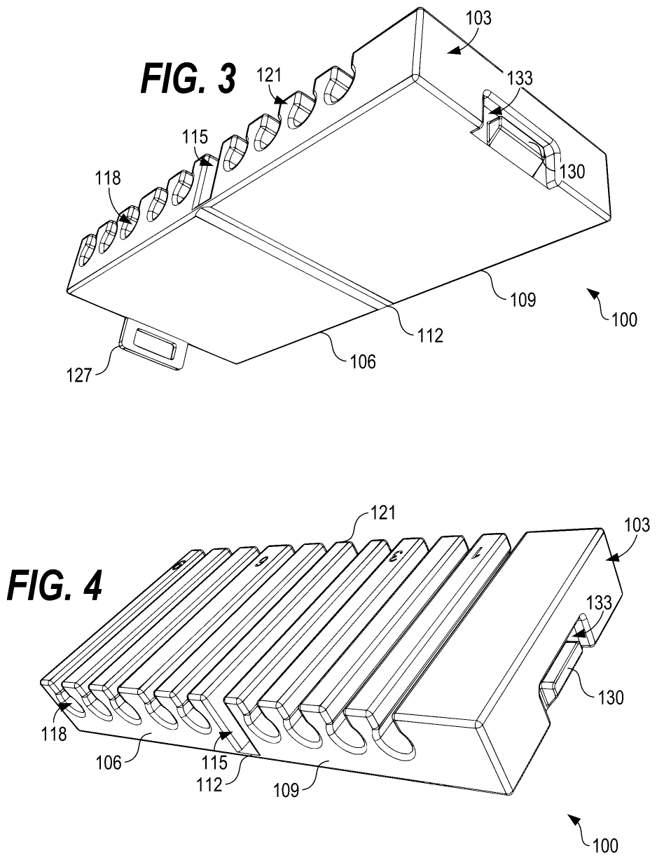

Turning now to the drawings, FIG. 1 shows a top perspective view of a cable clip 100 according to various embodiments. Further, FIGS. 2 and 3 show bottom perspective views of the cable clip 100 of FIG. 1, and FIG. 4 shows another top perspective view of the cable clip 100 according to various embodiments. With reference to FIGS. 1-4, in some cases, certain features or components may be exaggerated or simplified to enhance clarity and understanding of the disclosed embodiments. The relative sizes, proportions, and spatial relationships of various elements may be modified for illustrative purposes and may not necessarily reflect the exact dimensions or arrangements of an actual implementation. As such, the drawings should be interpreted as schematic representations rather than precise engineering diagrams, with the understanding that variations in size, shape, and proportion may occur in practical applications of the cable clip 100.

Referring collectively to FIGS. 1-4, the cable clip 100 has a cable clip body 103. In some aspects, the cable clip body 103 can include an integral body. For instance, various components of the cable clip body 103 can be formed out of a single piece of material such that the various components are integral with one another. In some examples, the cable clip body 103 can be injection molded out of a plastic, rubber, or other polymer material, although other materials can be employed. The integral cable clip body 103 can provide enhanced structural integrity, simplified manufacturing processes, and improved durability, among other benefits.

The cable clip body 103 can include a first section 106, a second section 109, and a connector portion 112. The connector portion 112 can couple the first section 106 to the the second section 109, and can be formed of a deformable piece of material that permits the first section 106 to move, pivot, and/or rotate relative to the second section 109, thereby facilitating folding or other manipulation of the cable clip 100. However, in some implementations, while being flexible, the connector portion 112 can have a predetermined rigidity to maintain the cable clip 100 in a side-by-side arrangement, shown in FIGS. 1-4, where the first section 106 and the second section 109 are arranged in a common plane P_{c}. In other words, the first section 106 and the second section 109 can be coplanar or aligned parallel with one another relative to a resting surface.

In some embodiments, the connector portion 112 is a thin piece of material that couples a lower surface of the first section 106 (i.e., a first lower surface) with a lower surface of the second section 109 (i.e., a second lower surface). The lower surfaces of the first section 106 and the second section 109 can be bottom surfaces, for example. A slot 115 can be positioned between bodies of the first section 106 and the second section 109, where the bodies have a rigidity greater than that of the connector portion 112. The slot 115 is aligned above the connector portion 112, and provides separation between the first section 106 and the second section 109. The slot 115 can be generally rectangular in some embodiments, however, other shapes and arrangements can be employed. The slot 115 further facilitates folding or other manipulation of the cable clip 100 by preventing the first section 106 from interfering with the second section 109 during the folding or other manipulation.

The first section 106 and the second section 109 can each include one or more cable channels 118, also referred to herein as channels 118 for short. The channels 118 can extend along a width of the first section 106 and the second section 109, permitting cables (not shown) to be snapped into or otherwise placed within respective ones of the channels 118. When situated in the channels 118, the cables can be oriented perpendicular to a longitudinal axis of the cable clip 100, although other orientations can be employed.

The channels 118 can include a shape that conforms or closely conforms to a shape of a desired cable for retainment by the cable clip 100. For instance, for cables having a circular cross-section, the channels 118 can be annular-shaped. For cables having a triangular cross-section, the channels 118 can be triangular-shaped. For cables having a square cross-section, the channels 118 can be square-shaped, and so forth.

As such, the cable clip 100 may include channels 118 of varying various configurations to accommodate different cable types and arrangements. In some additional examples, the channels 118 may have oval or elliptical cross-sections to hold flattened cables or ribbon cables. In other cases, the channels may feature a D-shaped profile to securely hold D-subminiature connectors or similar cable types. The cable clip 100 may also incorporate channels 118 with adjustable widths by virtue of the elasticity of the material forming up the cable 100, which can allow for accommodation of cables with different diameters. To this end, this adjustability can be provided using flexible side walls of the channels 118 or using insertable spacers (not shown) within the channels 118.

In certain implementations, the channels 118 can include textured or grooved surfaces to enhance grip on the cables and prevent slippage although, in other implementations, the channels 118 can include smooth uniform surfaces. Additionally, the channels 118 can include one or more strain reliefs. The strain reliefs can include curved entry points or flexible tabs, which may reduce stress on the cables at the point where they enter or exit the clip. In some embodiments, the channels 118 may include non-linear paths. For instance, the channels 118 can include breakaway sections, enabling operators to create pass-through openings for branching the cables or routing the cables into varying directions.

The channels 118 can be configured to closely conform to a cable cross-section such that each of the channels 118 are configured to form a snap connection and/or an interference fit with the cable. Thus, a diameter of the channels 118 can be the same or substantially similar to an outer diameter of a corresponding cable.

By virtue of the channels 118 being provided in the first section 106 and the second section 109, the cable clip body 103 includes a multitude of ridges 121 positioned between each of the channels 118. The ridges 121 are sized and positioned to provide a degree of flex or elasticity. As such, the ridges 121 can be configured to deflect upon insertion of the cables into the channels 118, facilitating placement of the cables in the channels 118. A space between the ridges 121 can be referred to as an insertion slot, where the insertion slot is in communication with a respective channel 118. As best seen in FIG. 2, each of the ridges 121 can have a width at a top that is greater than a width at its base. This enables the top of the ridge 121 to slightly curl over a top of a cable, further ensuring a tight fit between cables and the cable clip 100. The lower width at the base of each of the ridges 121 as well as the material forming the ridges 121 may also facilitate deflection.

In some embodiments, a notch 124 can be positioned in a lower surface of the cable clip body 103, thereby providing a notched lower surface. The notched lower surface, for example, can be positioned between the first section 106 and the second section 109. For instance, the notch 124 can be positioned below the slot 115 in the connector portion 112. The notch 124 can be a triangular-shaped notch, a semi-circular shaped notch, and so forth. By virtue of the placement of the notch 124 in the cable clip body 103, the notch 124 can further facilitate the folding or other manipulation of the cable clip body 103 to achieve differing configurations. The connector portion 112 acts as a living hinge that allows the first section 106 and the second section 109 to fold together and stay closed.

The cable clip body 103 can include one or more coupling features to secure the cable clip body 103 in a folded or closed state. For instance, the cable clip body 103 can further include a latch 127 and a tab 130. In some embodiments, the latch 127 can be positioned on a distal end of the first section 106, whereas the tab 130 can be positioned on a distal end of the second section 109. In other words, the latch 127 can be on a first end of the cable clip body 103 while the tab 130 can be positioned on a second, opposite end of the cable clip body 103.

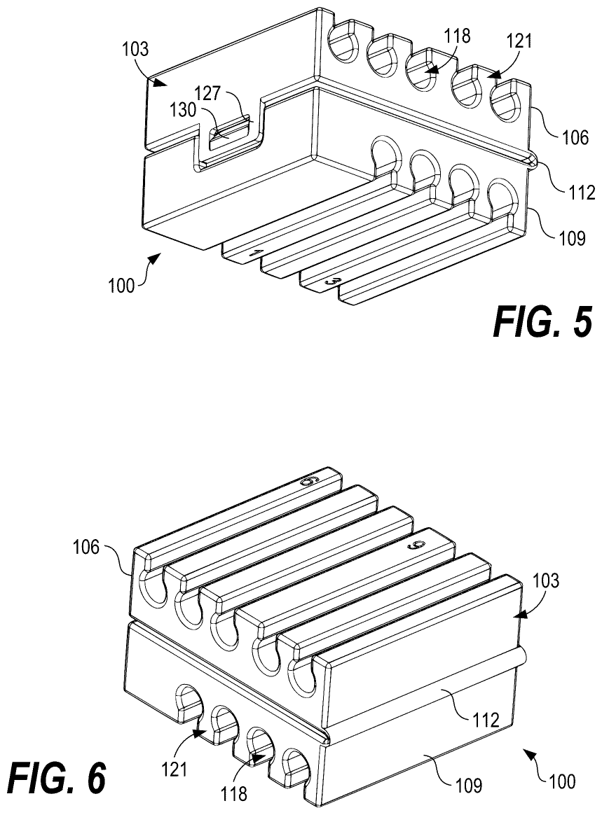

The latch 127 can extend downward from the cable clip body 103 in some scenarios. Thus, when the first section 106 and the second section 109 are folded about a folding axis af, the tab 130 can be positioned in an aperture 133 of the latch 127. In some embodiments, the cable clip body 103 can include a latch aperture 136 surrounding the tab 130 such that, when the latch 127 is engaged with the tab 130, the latch 127 nests with the tab 130, providing a generally flush surface. Thus, outer surfaces of the latch 127 and the tab 130 can be situated to be coplanar with a surface of a distal end of the second section 109, as shown in FIG. 5.

In addition to or in place of the latch 127 and the tab 130, the first section 106 and the second section 109 of the cable clip 100 can be coupled using other coupling mechanisms. For example, the cable clip 100 can include a snap-fit mechanism where protrusions on one section engage with corresponding recesses on the other section. Alternatively, the cable clip 100 can include a hook-and-loop fastener system, with one section featuring hooks and the other featuring loops. In some implementations, the cable clip 100 cam include a magnetic coupling system, where magnets embedded in each of the first section 106 and the second section 109 attract one another to secure the sections together.

In some embodiments, the cable clip 100 can include a sliding lock, where a sliding component of the sliding lock on the first section 106 engages with a track or groove on the second section 109. In some cases, the cable clip can include a twist-lock system, where one section rotates relative to the other to engage and lock in place. For applications requiring frequent access, the cable clip 100 can include a hinge with a clasp or locking mechanism.

FIG. 5 is a bottom perspective view of the cable clip 100 in a second configuration. Similarly, FIG. 6 is a top perspective view of the cable clip 100 in the second configuration. Referring to FIGS. 5 and 6 collectively, the second configuration can include the first section 106 and the second section 109 being bent or folded about the folding axis folding axis a_{f} (FIG. 2) such that a top-and-bottom configuration is formed in which a lower surface of the first section 106 and a lower surface of the second section 109 face one another. In some embodiments, a certain folding radius can be achieved such that the lower surface of the first section 106 and the lower surface of the second section 109 contact or touch one another.

According to various embodiments, the first section 106 includes five channels 118 and the second section 109 includes four channels 188. In the side-by-side configuration, a total of nine channels 118 are disposed laterally with respect to one another. In the top-and-bottom configuration, five channels 118 are positioned in a first row defined by the first section 106 and four channels 118 are positioned in a second row defined by the second section 109.

While various embodiments include a total of nine channels 118 in the cable clip 100, the disclosure is not so limited. Any number of channels 118 in the first section 106 and/or the second section 109 can be provided based on a desired orientation or arrangement of cables. In addition, while the embodiments of FIGS. 5 and 6 show the first section 106 having a differing number of channels 118 relative to the second section 109, in alternative embodiments, the first section 106 and the second section 109 can have a same or equal number of channels 118.

Referring again collectively to FIGS. 1-4, the cable clip 100 is shown in a first configuration. In the first configuration, the first section 106 and the second section 109 are arranged in a common plane Pc. In other words, the first section 106 and the second section 109 are coplanar and parallel, where the first section 106 is disposed laterally with respect to the second section 109, and vice versa. However, FIGS. 5-6 show the cable clip 100 in a second configuration.

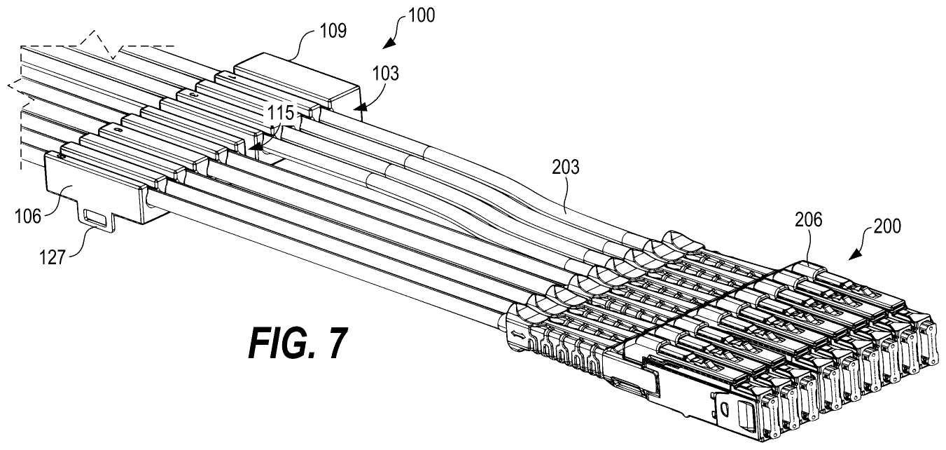

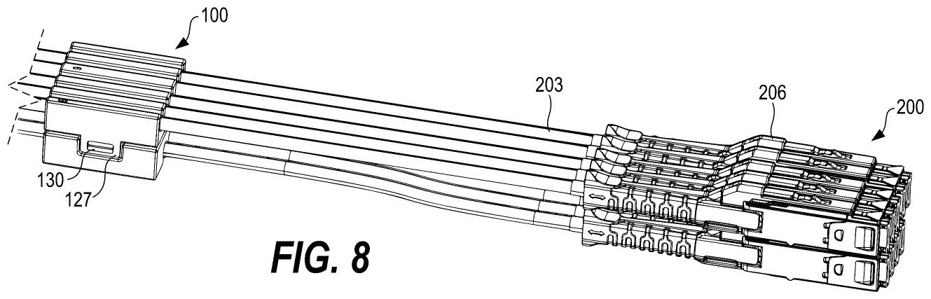

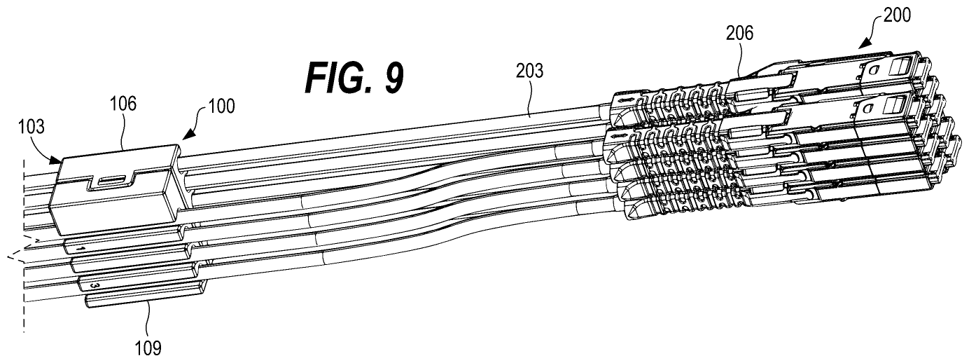

Referring now to FIGS. 7-9, various views of a connector assembly 200 featuring the cable clip 100 are illustrated. Specifically, FIG. 7 shows a top perspective view of the connector assembly 200 with the cable clip 100 in the first configuration, while FIGS. 8 and 9 depict the connector assembly 200 with the cable clip 100 in the second configuration.

In FIG. 7, the cable clip 100 is shown in its side-by-side configuration, where the first section 106 and the second section 109 are arranged laterally with respect to one another. The cable clip 100 can be positioned proximate an end (e.g., a termination end) of a bundle of connector cables 203. The channels 118 in both the first section 106 and the second section 109 may receive and retain individual cables from the bundle of connector cables 203. In some examples, the cables 203 can snap into the channels 118 of the cable clip 100. This arrangement can allow for an organized separation and routing of the cables 203 as they extend from the cable clip 100 towards a connector 206 or a port in which the connector 206 is disposed.

In some implementations, the connector 206 may be a multi-pin connector designed to interface with electronic equipment or other devices, as can be appreciated. The cable clip 100 can help maintain the organization of the connector cables 203 as they approach the connector 206, reducing strain on the connection points and improving overall cable management.

In some implementations, the cable clip 100 can accommodate varying types of cables in the first section 106 and the second section 109. For example, a first bundle of cables 203 retained in the channels 118 of the first section 106 may be of a different type compared to a second bundle of cables retained in the channels 118 of the second section 109. This configuration can allow for organization and management of diverse cable types within a single cable clip 100. The channels 118 in each section may be sized and shaped to accommodate the specific cable types with varying diameters, cross-sectional shapes, or other characteristics.

FIGS. 8 and 9 show top and bottom perspective views of the connector assembly 200, respectively, with the cable clip 100 in its second, folded configuration. The first section 106 and the second section 109 of the cable clip 100 are positioned in a top-and-bottom configuration, which can be desirable based on certain desired arrangements of the cables 203. The latch 127 and tab 130 are engaged to secure the cable clip 100 in this folded position. This configuration can allow for a more compact arrangement of the cables 203, which can be beneficial in space-constrained environments. For instance, the connector cables 203 emerge from the folded cable clip 100 as a more tightly bundled group compared to the side-by-side configuration shown in FIG. 7. This can provide a desirable appearance and improved routing of the cables to the connector 206. The folded configuration of the cable clip 100 can also provide additional support and strain relief for the connector cables 203. In some implementations, the folded configuration of the cable clip 100 can permit stacking or nesting of multiple cable clips 100, which may be beneficial in applications requiring the management of a large number of cables in a confined space.

The connector assembly 200, as shown in FIGS. 7-9, show versatility of the cable clip 100 in different cable management scenarios. The ability to transition between the side-by-side and folded configurations allow for adaptation to various spatial constraints and cable routing requirements. This flexibility can make the cable clip 100 suitable for use in a wide range of applications, from data centers and telecommunications equipment to automotive or aerospace wiring systems.

The cable clip 100 can accommodate a variety of connectors commonly used in data center, medical, automative, and other industrial applications. These connectors may include, but are not limited to, wire-to-wire connectors, wire-to-board connectors, automotive connectors, medical connectors, and so forth. In some implementations, the cable clip 100 can also be suitable for organizing and securing high-density connectors, modular connectors, or proprietary connectors used in specific industries or applications. The versatility of the cable clip 100 in accommodating different connector types can enhance its utility across a wide range of data center and industrial environments. In some aspects, the cable clip 100 can be configured to handle connectors with varying pin counts, current ratings, and so on.

The cable clip 100 can be fabricated using various manufacturing techniques. In some cases, the cable clip 100 can be injection molded using a suitable polymer or rubber material, allowing for the creation of complex shapes and features in a single molding process, reducing production costs, and improving consistency between individual cable clips 100.

The integral nature of the cable clip body 103 can extend to its various functional components. For example, the first section 106, second section 109, and the connector portion 112 described herein can all be part of this single, integral structure. This can help ensure proper alignment and interaction between these components, enhancing the overall functionality and reliability of the cable clip 100.

In some implementations, the material chosen for the cable clip body 103 can possess specific properties that enhance its performance. For instance, the material can have a degree of flexibility to allow for the transitioning between different configurations while maintaining sufficient rigidity to securely hold cables in place. The material can also be selected for its durability, resistance to environmental factors (e.g., heat), or other characteristics relevant to the intended application of the cable clip 100. Additionally, the material can be a material selected to improve or alter the signal integrity characteristics of the connector assembly 200.

In some implementations, the cable clip body 103 can be fabricated from various materials to achieve desired properties. For example, the cable clip body 103 can be formed of thermoplastic polymers such as polyethylene, polypropylene, polyamide (nylon), acrylonitrile butadiene styrene (ABS), or any combination thereof. These materials can provide a balance of flexibility and strength suitable for folding and cable retention of the cable clip 100. In some cases, thermoplastic elastomers (TPEs) can be employed for enhanced flexibility and grip. For applications requiring higher temperature resistance or increased durability, engineering plastics can be employed including, but not limited to, polyoxymethylene (POM) or polyetheretherketone (PEEK).

In various embodiments, the cable clip body 103 can incorporate reinforcing materials such as glass fibers or carbon fibers to enhance strength and rigidity while maintaining lightweight properties. The choice of material can be a function of various factors including, but not limited to, the intended application, the deployment environment, required mechanical properties, as well as various manufacturing considerations.

The features, structures, or characteristics described above can be combined in one or more embodiments in any suitable manner, and the features discussed in the various embodiments can be interchangeable, if possible. In the following description, numerous specific details are provided in order to fully understand the embodiments of the present disclosure. However, a person skilled in the art will appreciate that the technical solution of the present disclosure can be practiced without one or more of the specific details, or other methods, components, materials, and the like can be employed. In other instances, well-known structures, materials, or operations are not shown or described in detail to avoid obscuring aspects of the present disclosure.

Although the relative terms such as “on,” “below,” “upper,” and “lower” are used in the specification to describe the relative relationship of one component to another component, these terms are used in this specification for convenience only, for example, as a direction in an example shown in the drawings. It should be understood that if the device is turned upside down, the “upper” component described above will become a “lower” component. When a structure is “on” another structure, it is possible that the structure is integrally formed on another structure, or that the structure is “directly” disposed on another structure, or that the structure is “indirectly” disposed on the other structure through other structures.

In this specification, the terms such as “a,” “an,” “the,” and “said” are used to indicate the presence of one or more elements and components. The terms “comprise,” “include,” “have,” “contain,” and their variants are used to be open ended, and are meant to include additional elements, components, etc., in addition to the listed elements, components, etc. unless otherwise specified in the appended claims.

The terms “first,” “second,” and so forth are used only as labels, rather than a limitation for a number of the objects. It is understood that if multiple components are shown, the components can be referred to as a “first” component, a “second” component, and so forth, to the extent applicable.

The terms “about” and “substantially,” unless otherwise defined herein to be associated with a particular range, percentage, or related metric of deviation, account for at least some manufacturing tolerances between a theoretical design and manufactured product or assembly, such as the geometric dimensioning and tolerancing criteria described in the American Society of Mechanical Engineers (ASME®) Y14.5 and the related International Organization for Standardization (ISO®) standards. Such manufacturing tolerances are still contemplated, as one of ordinary skill in the art would appreciate, although “about,” “substantially,” or related terms are not expressly referenced, even in connection with the use of theoretical terms, such as the geometric “perpendicular,” “orthogonal,” “vertex,” “collinear,” “coplanar,” and other terms.

The above-described embodiments of the present disclosure are merely possible examples of implementations set forth for a clear understanding of the principles of the disclosure. Many variations and modifications can be made to the above-described embodiment(s) without departing substantially from the spirit and principles of the disclosure. All such modifications and variations are intended to be included herein within the scope of this disclosure and protected by the following claims.

Therefore, the following is claimed:

1. A cable clip, comprising:
a first section comprising a first lower surface;
a second section comprising a second lower surface;
a connector portion coupling the first section to the second section, wherein the first section and the second section are movably coupled to one another about the connector portion such that the first section and the second section are positionable between a side-by-side configuration in which the first section and the second section are disposed laterally with respect to one another, and a top-and-bottom configuration in which the first lower surface and the second lower surface face one another; and
a plurality of channels positioned in each of the first section and the second section, wherein the plurality of channels are configured to receive and retain a plurality of cables therein.

2. The cable clip according to claim 1, further comprising a slit positioned above the connector portion and between the first section and the second section that separates the first section from the second section.

3. The cable clip according to claim 1, further comprising a latch positioned on a distal end of the first section, and a tab positioned on a distal end of the second section, wherein the latch is configured to engage with and retain the tab when the first section and the second section are in the top-and-bottom configuration.

4. The cable clip according to claim 1, wherein each of the plurality of channels are annular-shaped, and each of the plurality of channels are configured to form an interference fit with a respective one of the plurality of cables.

5. The cable clip according to claim 1, wherein the connector portion comprises a notched lower surface positioned between the first lower surface and the second lower surface.

6. The cable clip according to claim 5, wherein the notched lower surface has a semi-circular or triangular cross-section that facilitates deformation of the notched lower surface.

7. The cable clip according to claim 1, wherein the first section, the second section, and the connector portion are integral with one another, and are formed of a single injection molded polymer material.

8. The cable clip according to claim 1, further comprising a plurality of ridges positioned between each of the plurality of channels, the ridges being configured to deflect upon insertion of a respective one of the plurality of cables.

9. The cable clip according to claim 1, wherein a number of the plurality of channels in the first section is the same as a number of the plurality of the channels in the second section.

10. A cable clip, comprising:
an integral body, comprising:
a first section and a second section;
a connector portion coupling the first section to the second section, wherein the first section and the second section are movably coupled to one another about the connector portion; and
a plurality of channels positioned in each of the first section and the second section, wherein the plurality of channels configured to receive and retain a plurality of cables therein.

11. The cable clip according to claim 10, wherein the connector portion is configured such that the first section and the second section are adjustable between a side-by-side configuration and a top-and-bottom configuration in which a first lower surface of the first section and a second lower surface of the second section are positioned adjacent one another.

12. The cable clip according to claim 10, wherein the integral body further comprises a slit positioned above the connector portion and between the first section and the second section that separates the first section from the second section.

13. The cable clip according to claim 10, wherein the integral body further comprises a latch positioned on a distal end of the first section, and a tab positioned on a distal end of the second section, wherein the latch is configured to engage with and retain the tab when the first section and the second section are in the top-and-bottom configuration.

14. The cable clip according to claim 10, wherein each of the plurality of channels are annular-shaped, and each of the plurality of channels are configured to form an interference fit with a respective one of the plurality of cables.

15. The cable clip according to claim 11, wherein the connector portion comprises a notched lower surface positioned between the first lower surface and the second lower surface, and wherein the notched lower surface has a cross-section that facilitates deformation of the notched lower surface.

16. The cable clip according to claim 10, wherein the first section, the second section, and the connector portion are integral with one another, and are formed of a single injection molded polymer material.

17. The cable clip according to claim 10, further comprising a plurality of ridges positioned between each of the plurality of channels, the ridges being configured to deflect upon insertion of a respective one of the plurality of cables.

18. A cable clip, comprising:
a first section comprising a first lower surface;
a second section comprising a second lower surface;
a plurality of channels positioned in each of the first section and the second section, wherein the plurality of channels are configured to receive and retain a plurality of cables therein; and
wherein the first section and the second section are movably coupled to one another such that the first section and the second section are positionable between a side-by-side configuration in which the first section and the second section are disposed laterally with respect to one another, and a top-and-bottom configuration in which the first lower surface and the second lower surface face one another.

19. The cable clip according to claim 18, further comprising a connector portion coupling the first section to the second section.

20. The cable clip according to claim 19, further comprising a slit positioned above the connector portion and between the first section and the second section that separates the first section from the second section.
